(19) United States
(12) Patent Application Publication
(10) Pub. No.: US 2014/0005432 A1
(43) Pub. Date: Jan. 2, 2014

(54) PROCESS FOR PREPARING ORGANOSILANES

(71) Applicant: Helmut Droege, Bornheim (DE)

(72) Inventor: Helmut Droege, Bornheim (DE)

(73) Assignee: Evonik Degussa GmbH, Essen (DE)

(21) Appl. No.: 13/146,520

(22) PCT Filed: Mar. 20, 2009
(86) PCT No.: PCT/CN2009/070912

§ 371 Date: Jul. 27, 2011

(51) Int. Cl. C07F 7/08

(52) U.S. Cl. 556/429; 556/427

(57) ABSTRACT

The invention provides a process for preparing organosilanes of the general formula (I) wherein a) (haloorganyl)alkoxysilane of the formula (II) is reacted with a sulphurising reagent selected from the group of alkali metal hydrogensulphide, metal sulphide M₂S, metal polysulphide M₂S_{g} and any desired combinations thereof and optionally additionally with sulphur and/or with H₂S in an organic solvent, b1) subsequently, the organic solvent is removed from the suspension which forms, and the liquid phase comprising the organosilane of the formula (I), and the solid phase comprising MX and residual organosilane of the formula (I), are separated from the remaining suspension, or b2) subsequently, the liquid phase comprising the organosilane of the formula (I) and the organic solvent, and the solid phase comprising MX and residual organosilane of the formula (I), are separated from the suspension which forms, and the organic solvent is removed from the liquid phase, c) the solid phase comprising MX and residual organosilane of the formula (I) is mixed with water and d) the organic phase which forms, comprising the organosilane of the general formula (I), is removed.

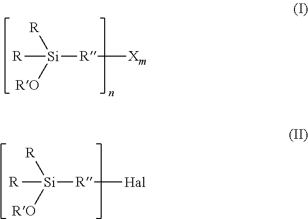

The invention relates to a process for preparing organosilanes.

It is known that silylalkylpolysulphanes can be prepared essentially by a nucleophilic substitution on chloroalkylsilanes with anionic polysulphides which have been prepared in various ways (DE-C2141159). The mixture consisting of the organosilicon compounds and the solid formed in the nucleophilic substitution, in the present case a salt, is worked up by filtration or centrifugation. The salt obtained is very fine when it precipitates out of an organic phase.

In addition, U.S. Pat. No. 6,777,569 discloses a process for preparing blocked mercaptosilanes, wherein the metal salt of a mercapto group-containing organosilicon compound is reacted with an acyl halide in the presence of toluene. The mixture consisting of the organosilicon compound and the salt formed in the nucleophilic substitution is worked up by completely dissolving the salt in demineralised water and then separating the phases. The phase separation is promoted to a crucial degree by the presence of toluene. The organic phase therefore comprises, as well as the organosilicon compound, toluene, which has to be removed by distillation after the phase separation.

U.S. Pat. No. 5,405,985, U.S. Pat. No. 5,468,893, U.S. Pat. No. 5,663,396, U.S. Pat. No. 5,583,245 and EP-A 0694552 disclose processes in which the corresponding polysulphide is prepared in aqueous solution from sulphides and sulphur, and reacted in a biphasic system with haloalkylsilanes in the presence of toluene and phase transfer catalyst to give polysulphanes. In this procedure, the mixture consisting of the organosilicon compound and the salt formed in the nucleophilic substitution is worked up by completely dissolving the salt in demineralised water and subsequently separating the phases. The phase separation is promoted to a crucial degree by the presence of toluene. The organic phase therefore comprises, as well as the organosilicon compound, toluene, which has to be removed by distillation after the phase separation. In this procedure, the phase transfer catalyst or degradation product thereof remains in the sulphur-containing organosilicon compounds.

In addition, U.S. Pat. No. 6,448,426, U.S. Pat. No. 6,384,255, U.S. Pat. No. 6,384,256, WO 03/002573, WO 03/002576, WO 03/002577, WO 03/002578 and WO 04/043969 disclose processes in which the corresponding polysulphide is prepared in aqueous solution from sulphides and sulphur or hydrogensulphides, alkali metal hydroxides and sulphur, and reacted in a biphasic system with haloalkylsilanes in the presence of a phase transfer catalyst to give polysulphanes. The mixture consisting of the organosilicon compound and the salt formed in the nucleophilic substitution is worked up by completely dissolving the salt in water and subsequently separating the phases. In this procedure, the phase transfer catalyst or degradation products thereof remain in the sulphur-containing organo silicon compounds with an as yet influence on the profile of performance values of the bis (silylalkyl)polysulphanes.

EP 1808436 discloses a process for preparing organosilicon compounds of the formula (R¹R²R³SiR⁴)₂Sₓ) by reacting haloalkoxysilanes of the formula R¹R²R³SiR⁴X with a dry polysulphide of the formula M₂S, and/or dry sulphide of the formula M₂S and optionally sulphur in an organic solvent, wherein the organic solvent is removed from the suspension which forms, the mixture comprising the organosilicon compound and the solid MX is mixed with water comprising at least one buffer, and the phases which form are separated.

The disadvantage of the known processes, in which the organosilicon compounds are prepared under anhydrous conditions, is the difficult and costly removal of the fine solids which form.

A further disadvantage of the known processes, in which the polysulphanes are obtained by reacting the corresponding polysulphide, which is obtained in aqueous solution from sulphides and sulphur, in a biphasic system with haloalkylsilanes in the presence of a solvent, for example toluene, is that the sulphur-containing organosilicon compounds have to be freed of the solvent, for example by vacuum distillation. Another disadvantage is that the resulting solvent may have to be dried before further use.

A further disadvantage of the known processes, in which the polysulphanes are obtained by reacting the corresponding polysulphide, which is obtained in aqueous solution from sulphides and sulphur, in a biphasic system with haloalkylsilanes in the presence of a phase transfer catalyst, is that the sulphur-containing organosilicon compounds are contaminated with the phase transfer catalyst or degradation products thereof.

It is an object of the invention to provide a process which enables the preparation of sulphur-containing organosilanes which are free of any phase transfer catalyst absolutely necessary by virtue of the process, or degradation products thereof, and affords a maximum yield.

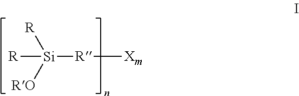

The invention provides a process for preparing organosilanes of the general formula I

where

R is the same or different and is a C₁-C₈-alkyl, preferably CH₃ or CH₂CH₃, C₁-C₈-alkenyl, C₁-C₈-aryl, C₁-C₈-aralkyl group or an OR′ group, R′ is the same or different and is a C₁-C₂₄, preferably C₁-C₄ or C₁₂-C₁₈, more preferably CH₂CH₃, branched or unbranched monovalent alkyl or alkenyl group, an aryl group, an aralkyl group, hydrogen (H), an alkyl ether group —(CR^{III}₂)—O-Alk or —(CR^{III}₂)_{y}—O-Alk or an alkyl polyether group —(CR^{III}₂O)_{y}-Alk or —(CR^{III}₂—CR^{III}₂—O)_{y}-Alk, where y=2-20, preferably 2-10, more preferably 3-6, R^{III} is independently H or an alkyl group, preferably CH₃ group, and Alk is a branched or unbranched, saturated or unsaturated, aliphatic, aromatic or mixed aliphatic/aromatic monovalent C₁-C₃₀, preferably C₂-C₂₀, more preferably C₆-C₁₈, most preferably //C₁₀-C₁₈, hydrocarbon group,

R″ is a branched or unbranched, saturated or unsaturated, aliphatic, aromatic or mixed aliphatic/aromatic divalent C₁-C₃₀, preferably C₁-C₂₀, more preferably C₁-C₁₀, most preferably C₁-C₇, hydrocarbon group which is optionally substituted by F, Cl, Br, I, HS, NH₂, or NHR′,

n is 1 or 2,

X═S when n=2 and m is a mean sulphur chain length of 1.5 to 4.5 and

X═SH when n=1 and m=1,

characterized in that

a) (haloorganyl)alkoxysilane of the formula II

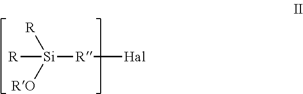

where R, R′ and R″ are each as defined above and Hal is chlorine, bromine, fluorine or iodine,

is reacted with a sulphurising reagent selected from the group of alkali metal hydrogensulphide, metal sulphide M₂S, metal polysulphide M₂S_{g} and any desired combinations thereof where M=alkali metal, ammonium or (alkaline earth metal)_{1/2}, and g=1.5-8.0,

and optionally additionally with sulphur and/or with H₂S in an organic solvent, b1) subsequently, the organic solvent is removed from the suspension which forms, and the liquid phase comprising the organosilane of the formula I, and the solid phase comprising MX and residual organosilane of the formula I, are separated from the remaining suspension, or

b2) subsequently, the liquid phase comprising the organosilane of the formula I and the organic solvent, and the solid phase comprising MX and residual organosilane of the formula I, are separated from the suspension which forms, and the organic solvent is removed from the liquid phase,

c) the solid phase comprising MX and residual organosilane of the formula I is mixed with water and

d) the organic phase which forms, comprising the organosilane of the general formula I, is removed.

Process steps b1) and b2) are alternative process steps.

In process step c), a surfactant can be added.

Process steps c) and d) can be performed more than once, preferably twice or three times, in succession.

In a process step e), the organosilane of the formula I from process step b1) or b2) can be mixed with the organosilane of the formula I from process step d). Subsequently, the organosilane of the formula I can be dried in a process step f).

The process according to the invention can be performed without catalyst, especially without phase transfer catalyst. Phase transfer catalysts may be understood to mean the catalysts named in WO 0302576, WO 0302577, WO 0302578 and WO 0302573.

The organosilanes of the general formula I may be a mixture of organosilanes of the general formula I.

The organosilanes of the general formula I where n=2 may be a mixture of organosilanes of the general formula I with different sulphur chain lengths m.

The organosilanes of the general formula I where n=2 may be bis(triethoxysilylpropyl)disulphane, bis(triethoxysilylpropyl)tetrasulphane, bis(methyldiethoxysilylpropyl)disulphane, bis(methyldiethoxysilylpropyl)tetrasulphane, bis(dimethylethoxysilylpropyl)disulphane, bis(dimethylethoxysilylpropyl)tetrasulphane,

[(MeO)₃Si(CH₂)₃]₂Sₘ, [(EtO)₃Si(CH₂)₃]₂Sₘ, [(C₃H₇O)₃Si(CH₂)₃]₂Sₘ,

[(C₁₂H₂₅O)₃Si(CH₂)₃]Sₘ[(CH₂)₃Si(C₁₂H₂₅O)₃],

[(C₁₄H₂₉O)₃Si(CH₂)₃]Sₘ[CH₂)₃Si(C₁₄H₂₉O)₃],

[(C₁₆H₃₃O)₃Si(CH₂)₃]Sₘ[CH₂)₃Si(C₁₆H₃₃O)₃],

[(C₁₈H₃₇O)₃Si(CH₂)₃]Sₘ[CH₂)₃Si(C₁₈H₃₇O)₃],

[(C₁₂H₂₅O)₃Si(CH₂)₃]Sₘ[CH₂)₃Si(C₁₂H₂₅O)₃],

[(C₁₄H₂₉O)₃Si(CH₂)₃]Sₘ[CH₂)₃Si(C₁₄H₂₉O)₃],

[(C₁₆H₃₃O)₃Si(CH₂)₃]Sₘ[CH₂)₃Si(C₁₆H₃₃O)₃],

[(C₁₈H₃₇O)₃Si(CH₂)₃]Sₘ[CH₂)₃Si(C₁₈H₃₇O)₃],

[C₁₂H₂₅O)₂(CH₃)Si(CH₂)₃]Sₘ[CH₂)₃Si(CH₃)(C₁₂H₂₅O)₂],

[C₁₂H₂₅O)(C₁₄H₂₉O)(CH₃)Si(CH₂)₃]Sₘ[(CH₂)₃Si(CH₃)(C₁₂H₂₅O)(C₁₄H₂₉O)],

[C₁₂H₂₅O)(C₁₄H₂₁O)(CH₃)Si(CH₂)₃]Sₘ[CH₂)₃Si(CH₃)(C₁₂H₂₅O)(C₁₂H₂₅O)],

[(C₁₂H₂₅O)(C₁₆H₃₃O)(CH₃)Si(CH₂)₃]Sₘ[CH₂)₃Si(CH₃)(C₁₂H₂₅O)(C₁₆H₃₃O)]

[(C₁₂H₂₅O)(C₁₈H₃₇O)(CH₃)Si(CH₂)₃]Sₘ[CH₂)₃Si(CH₃)(C₁₂H₂₅O)(C₁₈H₃₇O)],

[(C₁₂H₂₅O)(C₁₈H₃₇O) (CH₃)Si(CH₂)₃]Sₘ[CH₂)₃Si(CH₃) (C₁₂H₂₅O)(C₁₈H₃₇O)],

[C₁₄H₂₉O)₂(CH₃)Si(CH₂)₃]Sₘ[CH₂)₃Si(CH₃)(C₁₄H₂₉O)₂],

[(C₁₄H₂₉O)(C₁₆H₃₃O)(CH₃)Si(CH₂)₃]Sₘ[CH₂)₃Si(CH₃)(C₁₄H₂₉O)(C₁₆H₃₃O)],

[(C₁₄H₂₉O)(C₁₈H₃₇O)(CH₃)Si(CH₂)₃]Sₘ[CH₂)₃Si(CH₃)(C₁₄H₂₉O)(C₁₈H₃₇O)],

[(C₁₆H₃₃O)₂(CH₃)Si(CH₂)₃]Sₘ[CH₂)₃Si(CH₃)(C₁₆H₃₃0)₂],

[(C₁₆H₃₃O)(C₁₈H₃₇O)(CH₃)Si(CH₂)₃]Sₘ[CH₂)₃Si(CH₃)(C₁₆H₃₃O)(C₁₈H₃₇O)],

[(C₁₈H₃₇O)₂(CH₃)Si(CH₂)₃]Sₘ[CH₂)₃Si(CH₃)(C₁₈H₃₇O)₂],

[C₁₂H₂₅O)(CH₃)₂Si(CH₂)₃]Sₘ[CH₂)₃Si(CH₃)₂(C₁₂H₂₅O)],

[(C₁₂H₂₅O)(CH₃)₂Si(CH₂)₃]Sₘ[(CH₂)₃Si(CH₃)₂(C₁₄H₂₉O)],

[(C₁₂H₂₅O)(CH₃)₂Si(CH₂)₃]Sₘ[(CH₂)₃Si(CH₃)₂(C₁₆H₃₃O)],

[(C₁₂H₂₅O)(CH₃)₂Si(CH₂)₃]Sₘ[(CH₂)₃Si(CH₃)₂(C₁₈H₃₇O)],

[(C₁₄H₂₉O)(CH₃)₂Si(CH₂)₃]Sₘ[(CH₂)₃Si(CH₃)₂(C₁₄H₂₉O)],

[(C₁₄H₂₉O)(CH₃)₂Si(CH₂)₃]Sₘ[CH₂)₃Si(CH₃)₂(C₁₆H₃₃O )],

[(C₁₄H₂₉O)(CH₃)₂Si(CH₂)₃]Sₘ[CH₂)₃Si(CH₃)₂(C₁₈H₃₇O)],

[(C₁₆H₃₃O)(CH₃)₂Si(CH₂)₃]Sₘ[CH₂)₃Si(CH₃)₂(C₁₆H₃₃O)],

[(C₁₆H₃₃O)(CH₃)₂Si(CH₂)₃]Sₘ[CH₂)₃Si(CH₃)₂(C₁₈H₃₇O)] and

](C181⁻1370)(CH3)2Si(CH₂)₃lSₘ[CH₂)₃Si(CH₃)₂(C₁₈H₃₇0)] where m=3.5-4.5.

Organosilanes of the general formula I where n=1 may be:

3-mercaptopropyl(trimethoxysilane),

3-mercaptopropyl(dimethoxyhydroxysilane),

3-mercaptopropyl(triethoxysilane),

3-mercaptopropyl(diethoxyhydroxysilane),

3-mercaptopropyl(diethoxymethoxysilane),

3-mercaptopropyl(tripropoxysilane),

3-mercaptopropyl(dipropoxymethoxysilane),

3-mercaptopropyl(dipropoxyhydroxysilane),

3-mercaptopropyl(tridodecanoxysilane),

3-mercaptopropyl(didodecanoxyhydroxysilane),

3-mercaptopropyl(tritetradecanoxysilane),

3-mercaptopropyl(trihexadecanoxysilane),

3-mercaptopropyl(trioctadecanoxysilane),

3-mercaptopropyl(didodecanoxy)tetradecanoxysilane,

3-mercaptopropyl(dodecanoxy)tetradecanoxy(hexadecanoxy)silane,

3-mercaptopropyl(dimethoxymethylsilane),

3-mercaptopropyl(methoxymethylhydroxysilane),

3-mercaptopropyl(methoxydimethylsilane),

3-mercaptopropyl(hydroxydimethylsilane),

3-mercaptopropyl(diethoxymethylsilane),

3-mercaptopropyl(ethoxyhydroxymethylsilane),

3-mercaptopropyl(ethoxydimethylsilane),

3-mercaptopropyl(dipropoxymethylsilane),

3-mercaptopropyl(propoxymethylhydroxysilane),

3-mercaptopropyl(propoxydimethylsilane),

3-mercaptopropyl(diisopropoxymethylsilane),

3-mercaptopropyl(isopropoxydimethylsilane),

3-mercaptopropyl(dibutoxymethylsilane),

3-mercaptopropyl(butoxydimethylsilane),

3-mercaptopropyl(diisobutoxymethylsilane),

3-mercaptopropyl(isobutoxymethylhydroxysilane),

3-mercaptopropyl(isobutoxydimethylsilane),

3-mercaptopropyl(didodecanoxymethylsilane),

3-mercaptopropyl(dodecanoxydimethylsilane),

3-mercaptopropyl(ditetradecanoxymethylsilane),

3-mercaptopropyl(tetradecanoxymethylhydroxysilane),

3-mercaptopropyl(tetradecanoxydimethylsilane),

2-mercaptoethyl(trimethoxysilane),

2-mercaptoethyl(triethoxysilane),

2-mercaptoethyl(diethoxymethoxysilane),

2-mercaptoethyl(tripropoxysilane),

2-mercaptoethyl(dipropoxymethoxysilane),

2-mercaptoethyl(tridodecanoxysilane),

2-mercaptoethyl(tritetradecanoxysilane),

2-mercaptoethyl(trihexadecanoxysilane),

2-mercaptoethyl(trioctadecanoxysilane),

2-mercaptoethyl(didodecanoxy)tetradecanoxysilane,

2-mercaptoethyl(dodecanoxy)tetradecanoxy(hexadecanoxy) silane,

2-mercaptoethyl(dimethoxymethylsilane),

2-mercaptoethyl(methoxymethylhydroxysilane),

2-mercaptoethyl(methoxydimethylsilane),

2-mercaptoethyl(diethoxymethylsilane),

2-mercaptoethyl(ethoxydimethylsilane),

2-mercaptoethyl(hydroxydimethylsilane),

1-mercaptomethyl(trimethoxysilane),

1-mercaptomethyl(triethoxysilane),

1-mercaptomethyl(diethoxymethoxysilane),

1-mercaptomethyl(diethoxyhydroxysilane),

1-mercaptomethyl(dipropoxymethoxysilane),

1-mercaptomethyl(tripropoxysilane),

1-mercaptomethyl(trimethoxysilane),

1-mercaptomethyl(dimethoxymethylsilane),

1-mercaptomethyl(methoxydimethylsilane),

1-mercaptomethyl(diethoxymethylsilane),

1-mercaptomethyl(ethoxymethylhydroxysilane),

1-mercaptomethyl(ethoxydimethylsilane),

1,3-dimercaptopropyl(trimethoxysilane),

1,3-dimercaptopropyl(triethoxysilane),

1,3-dimercaptopropyl(tripropoxysilane),

1,3-dimercaptopropyl(tridodecanoxysilane),

1,3-dimercaptopropyl(tritetradecanoxysilane),

1,3-dimercaptopropyl(trihexadecanoxysilane),

2,3-dimercaptopropyl(trimethoxysilane),

2,3-dimercaptopropyl(triethoxysilane),

2,3-dimercaptopropyl(tripropoxysilane),

2,3-dimercaptopropyl(tridodecanoxysilane),

2,3-dimercaptopropyl(tritetradecanoxysilane),

2,3-dimercaptopropyl(trihexadecanoxysilane),

3-mercaptobutyl(trimethoxysilane),

3-mercaptobutyl(triethoxysilane),

3-mercaptobutyl(diethoxymethoxysilane),

3-mercaptobutyl(tripropoxysilane),

3-mercaptobutyl(dipropoxymethoxysilane),

3-mercaptobutyl(dimethoxymethylsilane),

3-mercaptobutyl(diethoxymethylsilane),

3-mercaptobutyl(dimethylmethoxysilane),

3-mercaptobutyl(dimethylethoxysilane),

3-mercaptobutyl(dimethylhydroxysilane),

3-mercaptobutyl(tridodecanoxysilane),

3-mercaptobutyl(tritetradecanoxysilane),

3-mercaptobutyl(trihexadecanoxysilane),

3-mercaptobutyl(didodecanoxy)tetradecanoxysilane,

3-mercaptobutyl(dodecanoxy)tetradecanoxy(hexadecanoxy) silane,

3-mercapto-2-methylpropyl(trimethoxysilane),

3-mercapto-2-methylpropyl(triethoxysilane),

3-mercapto-2-methylpropyl(diethoxymethoxysilane),

3-mercapto-2-methylpropyl(tripropoxysilane),

3-mercapto-2-methylpropyl(dipropoxymethoxysilane),

3-mercapto-2-methylpropyl(tridodecanoxysilane),

3-mercapto-2-methylpropyl(tritetradecanoxysilane),

3-mercapto-2-methylpropyl(trihexadecanoxysilane),

3-mercapto-2-methylpropyl(trioctadecanoxysilane),

3-mercapto-2-methylpropyl(didodecanoxy)tetradecanoxysilane,

3-mercapto-2-methylpropyl(dodecanoxy) tetradecanoxy(hexadecanoxy)silane,

3-mercapto-2-methylpropyl(dimethoxymethylsilane),

3-mercapto-2-methylpropyl(methoxydimethylsilane),

3-mercapto-2-methylpropyl(diethoxymethylsilane),

3-mercapto-2-methylpropyl(ethoxydimethylsilane),

3-mercapto-2-methylpropyl(hydroxydimethylsilane),

3-mercapto-2-methylpropyl(dipropoxymethylsilane),

3-mercapto-2-methylpropyl(propoxydimethylsilane),

3-mercapto-2-methylpropyl(diisopropoxymethylsilane),

3-mercapto-2-methylpropyl(isopropoxydimethylsilane),

3-mercapto-2-methylpropyl(dibutoxymethylsilane),

3-mercapto-2-methylpropyl(butoxydimethylsilane),

3-mercapto-2-methylpropyl(diisobutoxymethylsilane),

3-mercapto-2-methylpropyl(isobutoxydimethylsilane),

3-mercapto-2-methylpropyl(didodecanoxymethylsilane),

3-mercapto-2-methylpropyl(dodecanoxydimethylsilane),

3-mercapto-2-methylpropyl(ditetradecanoxymethylsilane),

3-mercapto-2-methylpropyl(tetradecanoxydimethylsilane),

[(C₉H₁₉O—(CH₂—CH₂O)₂](MeO)₂Si(CH₂)₃SH,

[(C₉H₁₉O—(CH₂—CH₂O)₃](MeO)₂Si(CH₂)₃SH,

[(C₉H₁₉O—(CH₂—CH₂O)₄](MeO)₂Si(CH₂)₃SH,

[(C₉H₁₉O—(CH₂—CH₂O)₅](MeO)₂Si(CH₂)₃SH,

[(C₉H₁₉O —(CH₂—CH₂O)₆](MeO)₂Si(CH₂)₃SH,

[(C₁₂H₂₅—(CH₂—CH₂O)₂](MeO)₂Si(CH₂)₃SH,

[(C₁₂H₂₅—(CH₂—CH₂O)₃](MeO)₂Si(CH₂)₃SH,

[(C₁₂H₂₅O—(CH₂—CH₂O)₄](MeO)₂Si(CH₂)₃SH,

[(C₁₂H₂₅O—(CH₂—CH₂O)₅](MeO)₂Si(CH₂)₃SH

[(C₁₂H₂₅O—(CH₂—CH₂O)₆](MeO)₂Si(CH₂)₃SH,

[(C₁₃H₂₇O—(CH₂—CH₂O)₂](MeO)₂Si(CH₂)₃SH,

[(C₁₃H₂₇O—(CH₂—CH₂O)₃](MeO)₂Si(CH₂)₃SH,

[(C₁₃H₂₇O—(CH₂—CH₂O)₄](MeO)₂Si(CH₂)₃SH,

[(C₁₃H₂₇O—(CH₂—CH₂O)₅](MeO)₂Si(CH₂)₃SH,

[(C₁₃H₂₇O—(CH₂—CH₂O)₆](MeO)₂Si(CH₂)₃SH,

[(C₁₄H₂₉O—(CH₂—CH₂O)₂](MeO)₂Si(CH₂)₃SH,

[(C₁₄H₂₉O—(CH₂—CH₂O)₃](MeO)₂Si(CH₂)₃SH,

[(C₁₄H₂₉O—(CH₂—CH₂O)₄](MeO)₂Si(CH₂)₃SH,

[(C₁₄H₂₉O—(CH₂—CH₂O)₅](MeO)₂Si(CH₂)₃SH,

[(C₁₄H₂₉O—(CH₂—CH₂O)₆](MeO)₂Si(CH₂)₃SH,

[(C₉H₁₉O—(CH₂—CH₂O)₂]₂(MeO)Si(CH₂)₃SH,

[(C₉H₁₉O—(CH₂—CH₂O)₃]₂(MeO)Si(CH₂)₃SH,

[(C₉H₁₉O —(CH₂—CH₂O)₄]₂(MeO)Si(CH₂)₃SH,

[(C₉H₁₉O—(CH₂—CH₂O)₅]₂(MeO)Si(CH₂)₃SH,

[(C₉H₁₉O—(CH₂—CH₂O)₆]₂(MeO)Si(CH₂)₃SH,

[(C₁₂H₂₅O—(CH₂—CH₂O)₂]₂(MeO)Si(CH₂)₃SH,

[)C₁₂H₂₅O—(CH₂—CH₂O)₃]₂(MeO)Si(CH₂)₃SH,

[(C₁₂H₂₅O—(CH₂—CH₂O)₄]₂(MeO)Si(CH₂)₃SH,

[(C₁₂H₂₅O—(CH₂—CH₂O)₅]₂(MeO)Si(CH₂)₃SH,

[(C₁₂H₂₅O—(CH₂—CH₂O)₆]₂(MeO)Si(CH₂)₃SH,

[(C₁₃H₂₇O—(CH₂—CH₂O)₂]₂(MeO)Si(CH₂)₃SH,

[(C₁₃H₂₇O—(CH₂—CH₂O)₃]₂(MeO)Si(CH₂)₃SH,

[(C₁₃H₂₇O—(CH₂—CH₂O)₄]₂(MeO)Si(CH₂)₃SH,

[(C₁₃H₂₇O—(CH₂—CH₂O)₅]₂(MeO)Si(CH₂)₃SH,

[(C₁₃H₂₇O—(CH₂—CH₂O)₆]₂(MeO)Si(CH₂)₃SH,

[(C₁₄H₂₉O—(CH₂—CH₂O)₂]₂(MeO)Si(CH₂)₃SH,

[(C₁₄H₂₉O—(CH₂—CH₂O)₃]₂(MeO)Si(CH₂)₃SH,

[(C₁₄H₂₉O—(CH₂—CH₂O)₄]₂(MeO)Si(CH₂)₃SH,

[(C₁₄H₂₉O—(CH₂—CH₂O)₅]₂(MeO)Si(CH₂)₃SH,

[(C₁₄H₂₉O—(CH₂—CH₂O)₆]₂(MeO)Si(CH₂)₃SH,

[(C₉H₁₉O—(CH₂—CH₂O)₂](EtO)₂Si(CH₂)₃SH,

[(C₉H₁₉O—(CH₂—CH₂O)₃](EtO)₂Si(CH₂)₃SH,

[(C₉H₁₉O—(CH₂—CH₂O)₄](EtO)₂Si(CH₂)₃SH,

[(C₉H₁₉O—(CH₂—CH₂O)₅](EtO)₂Si(CH₂)₃SH,

[(C₉H₁₉O—(CH₂—CH₂O)₆](EtO)₂Si(CH₂)₃SH,

[(C₁₂H₂₅O—(CH₂—CH₂O)₂](EtO)₂Si(CH₂)₃SH,

[(C₁₂H₂₅O—(CH₂—CH₂O)₃](EtO)₂Si(CH₂)₃SH,

[(C₁₂H₂₅O—(CH₂—CH₂O)₄](EtO)₂Si(CH₂)₃SH,

[(C₁₂H₂₅O—(CH₂—CH₂O)₅](EtO)₂Si(CH₂)₃SH,

[(C₁₂H₂₅O—(CH₂—CH₂O)₆](EtO)₂Si(CH₂)₃SH,

[(C₁₃H₂₇—(CH₂—CH₂O)₂](EtO)₂St(CH₂)₃SH,

[(C₁₃H₂₇O—(CH₂—CH₂O)₃](EtO)₂Si(CH₂)₃SH,

[(C₁₃H₂₇O—(CH₂—CH₂O)₄](EtO)₂Si(CH₂)₃SH,

[(C₁₃H₂₇O—(CH₂—CH₂O)₅](EtO)₂Si(CH₂)₃SH,

[(C₁₃H₂₇O—(CH₂—CH₂O)₆](EtO)₂Si(CH₂)₃SH,

[(C₁₄H₂₉O—(CH₂—CH₂O)₂](EtO)₂Si(CH₂)₃SH,

[(C₁₄H₂₉O—(CH₂—CH₂O)₃](EtO)₂Si(CH₂)₃SH,

[(C₁₄H₂₉O—(CH₂—CH₂O)₄](EtO)₂Si(CH₂)₃SH,

[(C₁₄H₂₉O—(CH₂—CH₂O)₅](EtO)₂Si(CH₂)₃SH,

[(C₁₄H₂₉O—(CH₂—CH₂O)₆](EtO)₂Si(CH₂)₃SH,

[(C₉H₁₉O—(CH₂—CH₂O)₂]₂(EtO)Si(CH₂)₃SH,

[(C₉H₁₉O—(CH₂—CH₂O)₃]₂(EtO)Si(CH₂)₃SH,

[(C₉H₁₉O—(CH₂—CH₂O)₄]₂(EtO)Si(CH₂)₃SH,

[(C₉H₁₉O—(CH₂—CH₂O)₅]₂(EtO)Si(CH₂)₃SH,

[(C₉H₁₉O—(CH₂—CH₂O)₆]₂(EtO)Si(CH₂)₃SH,

[(C₁₂H₂₅O—(CH₂—CH₂O)₂]₂(EtO)Si(CH₂)₃SH,

[(C₁₂H₂₅O—(CH₂—CH₂O)₃]₂(EtO)Si(CH₂)₃SH,

[(C₁₂H₂₅O—(CH₂—CH₂O)₄]₂(EtO)Si(CH₂)₃SH,

[(C₁₂H₂₅O—(CH₂—CH₂O)₅]₂(EtO)Si(CH₂)₃SH,

[(C₁₂H₂₅O—(CH₂—CH₂O)₆]₂(EtO)Si(CH₂)₃SH,

[(C₁₃H₂₇O—(CH₂—CH₂O)₂]₂(EtO)Si(CH₂)₃SH,

[(C₁₃H₂₇O—(CH₂—CH₂O)₃]₂(EtO)Si(CH₂)₃SH,

[(C₁₃H₂₇O—(CH₂—CH₂O)₄]₂(EtO)Si(CH₂)₃SH,

[(C₁₃H₂₇O—(CH₂—CH₂O)₅]₂(EtO)Si(CH₂)₃SH,

[(C₁₃H₂₇O—(CH₂—CH₂O)₆]₂(EtO)Si(CH₂)₃SH,

[(C₁₄H₂₉O—(CH₂—CH₂O)₂]₂(EtO)Si(CH₂)₃SH,

[(C14H₂₉O—(CH₂—CH₂O)₃]₂(EtO)Si(CH₂)₃SH,

[(C₁₄H₂₉O—(CH₂—CH₂O)₄]₂(EtO)Si(CH₂)₃SH,

[(C₁₄H₂₉O—(CH₂—CH₂O)₅]₂(EtO)Si(CH₂)₃SH,

[(C₁₄H₂₉O—(CH₂—CH₂O)₆]₂(EtO)Si(CH₂)₃SH,

[(C₉H₁₉O—(CH₂—CH₂O)₂]₃Si(CH₂)₃SH,

[(C₉H₁₉O—(CH₂—CH₂O)₃]₃Si(CH₂)₃SH,

[(C₉H₁₉O—(CH₂—CH₂O)₄]₃ Si(CH₂)₃SH,

[(C₉H₁₉O—(CH₂—CH₂O)₅]₃Si(CH₂)₃SH,

[(C₉H₁₉O—(CH₂—CH₂O)₆]₃ Si(CH₂)₃SH,

[(C₁₂H₂₅O—(CH₂—CH₂O)₂]₃ Si(CH₂)₃SH,

[(C₁₂H₂₅O—(CH₂—CH₂O)₃]₃Si(CH₂)₃SH,

[(C₁₂H₂₅O—(CH₂—CH₂O)₄]₃ Si(CH₂)₃SH,

[(C₁₂H₂₅O—(CH₂—CH₂O)₅]₃Si(CH₂)₃SH,

[(C₁₂H₂₅O—(CH₂—CH₂O)₆]₃ Si(CH₂)₃SH,

[(C₁₃H₂₇O—(CH₂—CH₂O)₂]₃Si(CH₂)₃SH,

[(C₁₃H₂₇O—(CH₂—CH₂O)₃]₃Si(CH₂)₃SH,

[(C₁₃H₂₇O—(CH₂—CH₂O)₄]₃ Si(CH₂)₃SH,

[(C₁₃H₂₇O—(CH₂—CH₂O)₅]₃Si(CH₂)₃SH,

[(C₁₃H₂₇O —(CH₂—CH₂O)₆]₃Si(CH₂)₃SH,

[(C₁₄H₂₉O—(CH₂—CH₂O)₂]₃Si(CH₂)₃SH,

[(C₁₄H₂₉O—(CH₂—CH₂O)₃]₃ Si(CH₂)₃SH,

[(C₁₄H₂₉O—(CH₂—CH₂O)₄]₃Si(CH₂)₃SH,

[(C₁₄H₂₉O—(CH₂—CH₂O)₅]₃ Si(CH₂)₃SH or

[(C₁₄H₂₉O—(CH₂—CH₂O)₆]₃ Si(CH₂)₃SH.

The (haloorganyl)alkoxysilanes of the formula II used may preferably be

3-chlorobutyl(triethoxysilane),

3-chlorobutyl(trimethoxysilane),

3-chlorobutyl(diethoxymethoxysilane),

3-chloropropyl(triethoxysilane),

3-chloropropyl(trimethoxysilane),

3-chloropropyl(diethoxymethoxysilane),

2-chloroethyl(triethoxysilane),

2-chloroethyl(trimethoxysilane),

2-chloroethyl(diethoxymethoxysilane),

1-chloromethyl(triethoxysilane),

1-chloromethyl(trimethoxysilane),

1-chloromethyl(diethoxymethoxysilane),

3-chloropropyl(diethoxymethylsilane),

3-chloropropyl(dimethoxymethylsilane),

2-chloroethyl(diethoxymethylsilane),

2-chloroethyl(dimethoxymethylsilane),

1-chloromethyl(diethoxymethylsilane),

1-chloromethyl(dimethoxymethylsilane),

3-chloropropyl(ethoxydimethylsilane),

3-chloropropyl(methoxydimethylsilane),

2-chloroethyl(ethoxydimethylsilane),

2-chloroethyl(methoxydimethylsilane),

1-chloromethyl(ethoxydimethylsilane) or

1-chloromethyl(methoxydimethylsilane).

The (haloorganyl)alkoxysilane may be a (haloorganyl)alkoxysilane of the formula II or a mixture of (haloorganyl)alkoxysilanes of the formula II.

The reactants of process step a), (haloorganyl)alkoxysilanes of the formula II and the sulphurising reagent, can be initially charged together in a solvent or solvent mixture and reacted, or one of the two reactants is metered as such or as a solution into the second reactant. The second reactant may likewise be present as a substance or as a solution. For the inventive performance of the process, it cannot be critical which of the two reactants is initially charged and which is metered in.

In a preferred embodiment of the invention, the two reactants, (haloorganyl)alkoxysilane of the formula II and sulphurising reagent, can be initially charged in an organic solvent or solvent mixture and then reacted.

The organic solvent may be an inert organic solvent. The organic solvent may be ethers, for example diethyl ether, diisopropyl ether, dibutyl ether, methyl tert-butyl ether, tetrahydrofuran, dioxane, dimethoxyethane and diethoxyethane, alcohols, for example methanol, ethanol, propanol and ethylene glycol, and aliphatic or aromatic hydrocarbons, for example pentane, hexane, heptane, petroleum ether, benzene, toluene and xylene. The organic solvent may be selected such that undesired transesterifications on the silicon atom are ruled out. Preferred organic solvents may be alcohols, in which case, in a particularly preferred embodiment, the alcohol used corresponds to the alkoxy group bonded within the alkoxysilyl radical. More preferably, the organic solvent used may be ethanol when one of the OR' groups in formula I is an ethoxy group.

The organic solvent may have a water content of 35% by weight, preferably 5-20% by weight, more preferably 7-15% by weight.

The reaction time may depend on the reaction temperature. The higher the reaction temperature, the shorter the time needed for complete reaction of the (haloorganyl)alkoxysilane of the formula II with the sulphurising reagents may be. The reaction time may be 0.1 to 10 h, preferably 2 h to 5 h.

The sulphurising reagent M₂S_{g} may have a water content of ≦10% by weight, preferably 5% by weight, more preferably 2% by weight, most preferably 1% by weight.

The sulphurising reagent M₂S may have a water content of ≦70% by weight, preferably 20-60% by weight, more preferably 30-50% by weight, most preferably 35-40% by weight.

The sulphurising reagent MSH may have a water content of 80% by weight, preferably 10-70% by weight, more preferably 20-60% by weight, most preferably 30-55% by weight.

In process step a), a buffer can be added.

The buffer of process step a), which keeps the buffer solution within an optimal pH range for the stability of the organosilane, may be varied substantially in terms of type and concentration. The buffers used may be organic and inorganic acids and bases and salts thereof, preferably alkali metal, alkaline earth metal or ammonium salts of carboxylic acids, phosphoric acid, sulphuric acid, C₁-C₆ organo-, mono- or polycarboxylic acids. The buffers used may, for example, be NaHCO₃, Na₂CO₃, ammonium carbonate, sodium borate, monosodium phosphate, disodium phosphate, trisodium phosphate, monopotassium phosphate, dipotassium phosphate, tripotassium phosphate, monosodium sulphate, disodium sulphate, sodium acetate, potassium acetate, ammonium acetate, calcium acetate, sodium formate, sodium sulphide, sodium hydrogensulphide, ammonia, monoethylamine, diethylamine, triethylamine, monoethanolamine, diethanolamine, triethanolamine, pyridine and aniline. Combinations of these buffers or combinations of these buffers with other buffers, for example acids or bases, may likewise be used.

Preferred buffers may be sodium carbonate and sodium hydrogencarbonate.

The buffer may be present in a concentration of 0.1 to 80% by weight, preferably 0.1 to 20% by weight, more preferably 0.1 to 10% by weight, most preferably 0.1 to 5% by weight, based on the starting mixture.

The buffer can be added with the organic solvent or one of the reactants.

The temperature in process step a) may be 20-120° C., preferably 50-70° C.

Process step a) can be carried out in a reactor with a stirring unit.

In process step a), it is possible to use an anionic surfactant, a nonionic surfactant or a combination of anionic and nonionic surfactants, for example a mixture of sodium n-alkylbenzenesulphonates and fatty alcohol ether sulphates, and ethanol.

The organic solvent can be removed from the suspension by distillation in process step b1) or b2). The organic solvent may form an azeotrope with the water. The organic solvent removed may comprise water.

The solid phase can be separated in process step b1) or b2) from the liquid phase by filtration, centrifugation, decantation, sedimentation, extractive pressing or discharge of the liquid phase. For the filtration, a pressure filter, a vacuum filter, a decanter or a filter centrifuge can preferably be used.

The amount of water added in process step c) may be 1% by weight −400% by weight, preferably 1% by weight −200% by weight, more preferably 5% by weight −30% by weight, based on the solid phase. The amount of water added in process step c) can be selected such that only a portion of the solid phase is dissolved. The amount of water added in process step c) may be lower than the amount of solid phase present.

The addition of the water in process step c) can be carried out at a temperature of 0-100° C., preferably 10-80° C., more preferably 10-30° C.

The phases which form after the addition of the water may form after a wait time within 2 0 0.1 sec to 10 days, preferably within 10 s to 10 h.

The surfactant optionally added in process step c) may be an anionic surfactant, for example alkylsulphate or alkylbenzenesulphonate, cationic surfactant, for example tetraalkylammonium salt, amphoteric surfactant, for example compounds with quaternary ammonium groups and COOH groups, and nonionic surfactant, for example fatty alcohol polyglycol ether or alkylpolyglycoside.

The surfactant may be fatty alcohol ethoxylate, polyacrylic acid or/and derivatives thereof, copolymer containing acrylic acid, acrylic acid derivative, lecithin, lignosulphonate, alkylbenzenesulphonate, naphthalenesulphonic acid derivative, copolymer containing maleic anhydride and/or maleic acid derivatives, an alcohol, an ether or combinations of the surfactants mentioned.

The surfactant used may preferably be an anionic surfactant, for example sodium n-alkylbenzenesulphonate or fatty alcohol ether sulphate, a nonionic surfactant, for example an alcohol, preferably ethanol, or a combination of anionic and nonionic surfactants.

The surfactant concentration in the water may be 0-10% by weight, preferably 0.1-5% by weight, more preferably 0.1-2% by weight.

The solid phase obtained after the separation of the phases (process step b1) or b2)) may, in process step c), be admixed first with water and then with a surfactant. The solid phase obtained after the separation of the phases (process step b1) or b2)) may, in process step c) be admixed first with a surfactant and then with water.

The solid phase obtained after the separation of the phases (process step b1) or b2)) may, in process step c), be admixed with a water/surfactant mixture. Instead of water, it is also possible to use an aqueous salt solution. The salt may be a chloride, carbonate, hydrogencarbonate, sulphate, sulphite and/or phosphate of the alkali metals or alkaline earth metals, or mixtures thereof, preferably sodium chloride and sodium hydrogencarbonate.

The organic phase can be removed in process step d) by filtration, centrifugation, sedimentation, decantation or extractive pressing. Simultaneously with the organic phase, an aqueous phase consisting of water and salt may form. This salt solution can be used instead of water in process step c).

Process steps c) and d) can be performed simultaneously.

The advantages of the process according to the invention are that the yield can be enhanced significantly.

### EXAMPLES

### Example 1

a) 200 kg of chloropropyltriethoxysilane are reacted with 36 kg of sulphur and 50 kg of sodium sulphide containing water of crystallisation (water content=37% by weight) in the presence of 15 kg of sodium hydrogencarbonate and 80 kg of ethanol-water mixture (15% by weight of water) to give the product.

b1) Subsequently, the solvent is removed from the suspension by distillation.

The subsequent solid-liquid separation is effected by means of a filter centrifuge. The liquid phase contains 206 kg of bis(triethoxysilylpropyl)tetrasulphane product.

c) 70 kg of the solid obtained from the solid-liquid separation is mixed with 70 kg of a surfactant/water mixture. The concentration of the surfactant in water is 0.3% by weight. The surfactant is a mixture of anionic and nonionic surfactants. The anionic surfactant is a mixture of sodium n-alkylbenzenesulphonates and fatty alcohol ether sulphates. The nonionic surfactant is ethanol.

d) The resulting suspension is supplied to a filter centrifuge. The filtrate is phase-separated and contains 5.2 kg of organic phase.

15 kg are taken from the aqueous phase of the filtrate and supplied again to the centrifuge (without again adding water). This provides a filtrate which contains a further 1.9 kg of organic phase.

After a further addition of 15 kg from the aqueous phase of the filtrate, another 0.3 kg of organic phase is obtained.

After distilling the organic phase obtained in process step d) (7.4 kg in total), 6.5 kg of product are obtained. Performance tests show that the product thus obtained is indistinguishable from the standard product.

The experiment shows that organosilane can be removed from the solid from process step b1) without completely dissolving the solid.

The yield based on the starting materials after process step b1) is 94% of theory and can be increased to 97% of theory through the performance of process steps c) and d).

### Example 2

In each case 100 g of solid from process step b1) of Example 1 is admixed with different amounts of water and wetting agent concentrations in process step c), and mixed for 5 minutes. Subsequently, the suspension is separated into its phases by means of a separator centrifuge (process step d)). Table 1 which follows shows the different mixtures and the appearance of the organic phase.

TABLE 1

| | | Amount of | Amount of | |
|---|---|---|---|---|
| Mixture | Amount of | surfactant | organic phase | Appearance of the |
| No. | water (g) | (g) | (g) | organic phase |
| 1 | 20 | 0 | 6.5 | green, cloudy |
| 2 | 100 | 0 | 0 | no organic phase |
| 3 | 20 | 0.2 | 8.5 | yellow, clear |
| 4 | 50 | 1 | 12.2 | yellow, clear |

1. Process for preparing organosilanes of the general formula I 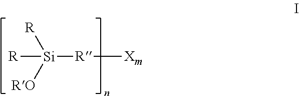
where
R is the same or different and is a C₁-C₈-alkyl, C₁-C₈-alkenyl, C₁-C₈-aryl, C₁-C₈-aralkyl group or an OR′ group,
R′ is the same or different and is a C₁-C₂₄ branched or unbranched monovalent alkyl or alkenyl group, an aryl group, an aralkyl group, hydrogen (—H), an alkyl ether group O—(CR^{III}₂)—O-Alk or O—(CR^{III}₂)_{y}—O-Alk or an alkyl polyether group O—(CR^{III}₂O)_{y}-Alk or O—(CR^{III}₂—CR^{III}₂—O)_{y}-Alk, where y=2-20, R^{III} is independently H or an alkyl group and Alk is a branched or unbranched, saturated or unsaturated, aliphatic, aromatic or mixed aliphatic/aromatic monovalent C₁-C₃₀ hydrocarbon group,
R″ is a branched or unbranched, saturated or unsaturated, aliphatic, aromatic or mixed aliphatic/aromatic divalent C₁-C₃₀ hydrocarbon group which is optionally substituted by F, Cl, Br, I, HS, NH₂, or NHR′,
n is 1 or 2,
X═S when n=2 and m is a mean sulphur chain length of 1.5 to 4.5 and
X═SH when n=1 and m=1,
wherein
a) (haloorganyl)alkoxysilane of the formula II 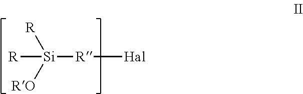
where R, R′ and R″ are each as defined above and Hal is chlorine, bromine, fluorine or iodine,
is reacted with a sulphurising reagent selected from the group of alkali metal hydrogensulphide, metal sulphide M₂S, metal polysulphide M₂S_{g} and any desired combinations thereof where M=alkali metal, ammonium or (alkaline earth metal)_{1/2}, and g=1.5-8.0,
and optionally additionally with sulphur and/or with H₂S in an organic solvent,
b1) subsequently, the organic solvent is removed from the suspension which forms, and the liquid phase comprising the organosilane of the formula I, and the solid phase comprising MX and residual organosilane of the formula I, are separated from the remaining suspension, or
b2) subsequently, the liquid phase comprising the organosilane of the formula I and the organic solvent, and the solid phase comprising MX and residual organosilane of the formula I, are separated from the suspension which forms, and the organic solvent is removed from the liquid phase,
c) the solid phase comprising MX and residual organosilane of the formula I is mixed with water and
d) the organic phase which forms, comprising the organosilane of the general formula I, is removed.

2. Process for preparing organosilanes according to claim 1, wherein a buffer is used in process step a).

3. Process for preparing organosilanes according to claim 1, characterized in that wherein a surfactant is added in process step c).

4. Process for preparing organosilanes according to claim 1, characterized in that wherein process steps c) and d) are performed more than once in succession.

5. Process for preparing organosilanes according to claim 2, wherein a surfactant is added in process step c).

6. Process for preparing organosilanes according to claim 5, wherein process steps c) and d) are performed more than once in succession.

7. Process for preparing organosilanes according to claim 2, wherein process steps c) and d) are performed more than once in succession.

8. Process for preparing organosilanes according to claim 3, wherein process steps c) and d) are performed more than once in succession.
